(19) United States
(12) Patent Application Publication
(10) Pub. No.: US 2011/0032296 A1
(43) Pub. Date: Feb. 10, 2011

(54) PRINTING APPARATUS AND PRINTING METHOD

(75) Inventors: Takatoshi Nakano, Tokyo (JP); Kiichiro Takahashi, Yokohama-shi (JP); Minoru Teshigawara, Saitama-shi (JP); Tetsuya Edamura, Kawasaki-shi (JP); Akiko Maru, Tokyo (JP); Hiroshi Taira, Chofu-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/836,132

(22) Filed: Jul. 14, 2010

(30) Foreign Application Priority Data
Aug. 6, 2009 (JP) 2009-183540

(51) Int. Cl. B41J 29/38

(52) U.S. Cl. 347/14

(57) ABSTRACT

A printing apparatus includes a plurality of print element arrays each with a plurality of print elements arranged therein. The printing apparatus prints an image by time division driving in which the plurality of print elements in each print element array are divided into a plurality of blocks and in which the print elements are driven for every block. The amount of misalignment among the print element arrays in an arrangement direction of the print elements is acquired. A print element group used for printing in at least one print element arrays is changed in accordance with the acquired misalignment amount to correct the misalignment among the print element arrays. A driving order of the blocks is changed in accordance with the misalignment amount. Even in the case of the time division driving, the misalignment of the dot formation positions can be eliminated.

### BACKGROUND OF THE INVENTION

1. Field of the Invention

The present invention relates to a printing apparatus and a printing method, and in particular, to a printing apparatus and a printing method for printing images by time division driving in which a plurality of print elements in a print head are driven in order for every block.

2. Description of the Related Art

In general, an ink jet printing apparatus includes a print head with a plurality of print elements arranged therein. The print head includes ejection ports through which ink droplets are ejected, and an energy generation unit for allowing ink droplets to be ejected through the ejection ports, for example, heaters or piezoelectric elements. The ink jet printing apparatus includes print heads for the respective colors such as cyan, magenta, yellow, and black, that is, a plurality of print heads corresponding to the colors.

The ink jet printing apparatus prints an image on a print medium by repeating print scan in which the print heads are moved in a main scanning direction, while ejecting ink droplets onto the print medium, and conveyance of the print medium in a sub-scanning direction crossing the main scanning direction. The sub-scanning direction coincides with a direction in which the print elements are arranged in each of the print heads.

It is difficult for the ink jet printing apparatus to have a power supply capacity sufficient to allow ink droplets to be ejected through all the ejection ports in each ejection port row, that is, each print element row in the print head. This is because for example, such a power supply capacity increases costs for a power supply device. Thus, to avoid this problem, the print elements may be driven in a time division manner. That is, the plurality of print elements in the print head are divided into a plurality of groups. The print elements in each of the groups are assigned to different blocks. Sets of print elements in each of the groups which belong to the same block are sequentially driven for every block at time intervals. Finishing driving of all the blocks means finishing driving of all the print elements. This operation is repeated in the main scanning direction to print a print area for one main scan.

Owing to assembly errors in the print heads which may occur during manufacturing or installation errors in the print heads which may occur during replacement if the print heads are replaceable, the print element arrays may be installed out of alignment with the original reference positions thereof in the sub-scanning direction. Then, positions on the print medium where dots are formed by ejection of ink droplets may be misaligned in the sub-scanning direction.

To solve this problem, a proposal has been made in which a range of use (print element group) in the print element array is shifted in accordance with the misalignment amount among the print element arrays in the sub-scanning direction. Japanese Patent Application Laid-Open No. H11-170501 (1999) discloses a technique for using one of a plurality of print heads (print element arrays) misaligned with the reference position by the largest or smallest degree to adjust the amount of misalignment of the other print heads (print element arrays)

However, in the time division driving, the misalignment of the dot formation positions cannot be eliminated only by the shifting of the range of use in the print element array. Thus, disadvantageously, a dot arrangement pattern may vary among the colors, resulting in degraded print quality such as a variation in color and an inappropriate sense of granularity.

Thus, the present invention has been developed in view of the above-described circumstances. An object of the present invention is to provide a printing apparatus and a printing method which enable the degradation of print quality resulting from the misalignment among the plurality of print element arrays to be inhibited.

### SUMMARY OF THE INVENTION

An aspect of the present invention provides a printing apparatus including a plurality of print element arrays each with a plurality of print elements arranged therein, the printing apparatus printing an image by time division driving in which the plurality of print elements in each print element array are divided into a plurality of blocks and in which the print elements are driven for every block, the apparatus comprising:

an acquisition unit for acquiring the amount of misalignment among the print element arrays in an arrangement direction of the print elements;

a correction unit for changing a print element group used for printing in at least one print element array in accordance with a misalignment amount acquired by the acquisition unit to correct the misalignment among the print element arrays; and

a changing unit for changing a driving order of the blocks in accordance with the misalignment amount.

In this aspect, not only the range of use in the print element array (print element group) is shifted but also the order in which the blocks are driven is changed. This enables misalignment of dot formation positions to be eliminated even in the case of the time division driving. As a result, possible degradation of image quality can be inhibited.

Another aspect of the present invention provides a printing method of using a plurality of print element arrays each with a plurality of print elements arranged therein to print an image by time division driving in which the plurality of print elements in each of the print element arrays are divided into a plurality of blocks and in which the print elements are driven for every block, the method including:

an acquisition step of acquiring the amount of misalignment among the print element arrays in an arrangement direction of the print elements;

a correction step of changing a print element group used for printing in at least one print element array in accordance with the misalignment amount acquired in the acquisition step to correct the misalignment among the print element arrays; and

a changing step of changing a driving order of the blocks in accordance with the misalignment amount.

The present invention is very effective for inhibiting the degradation of print quality resulting from the misalignment among the plurality of print element arrays.

Further features of the present invention will become apparent from the following description of exemplary embodiments (with reference to the attached drawings).

### BRIEF DESCRIPTION OF THE DRAWINGS

FIG. 1 is a perspective view showing an ink jet printing apparatus according to the present embodiment;

FIG. 2 is a perspective view of a cartridge;

FIG. 3 is a diagram showing ink ejection port surfaces of a plurality of print heads;

FIG. 4 is a diagram showing an ink ejection port row in a print head, and nozzle numbers, blocks, and groups corresponding to each ink ejection port;

FIG. 5 is a block diagram showing the configuration of a control circuit;

FIG. 6 is an internal block diagram of an ASIC in a reference example;

FIG. 7 is a diagram showing the configuration of a third print memory;

FIGS. 8A-8C are diagrams showing block driving order data;

FIG. 9 is a diagram showing a driving circuit configured to drive print heads;

FIG. 10 is a time chart showing timings for signals such as a block enable signal;

FIG. 11 is a diagram showing a relationship among FIGS. 11A-11C;

FIGS. 11A-11C are diagrams showing dot arrangement for cyan and magenta in which no color misalignment occurs;

FIG. 12 is a diagram showing dot arrangement for cyan and magenta after printing in which no color misalignment occurs;

FIG. 13 is a diagram showing a relationship among FIGS. 13A-13C;

FIGS. 13A-13C are diagrams showing dot arrangement for cyan and magenta in which color misalignment has occurred;

FIG. 14 is a diagram showing dot arrangement for cyan and magenta after printing in which color misalignment has occurred;

FIG. 15 is a diagram showing a relationship among FIGS. 15A-15C;

FIGS. 15A-15C are diagrams showing dot arrangement for cyan and magenta in which color misalignment has occurred and in which print element groups used have thus simply been shifted;

FIG. 16 is a diagram showing dot arrangement for cyan and magenta after printing in which color misalignment has occurred and in which print element groups have thus simply been shifted;

FIG. 17 is a diagram showing a relationship among FIGS. 17A-17C;

FIGS. 17A-17C are diagrams showing dot arrangement for cyan and magenta in which color misalignment has occurred but been corrected in accordance with the present invention;

FIG. 18 is an internal block diagram of an ASIC according to the present embodiment;

FIG. 19 is a table specifying the relationship between the amount of color misalignment and a driving block offset value;

FIG. 20 is a flowchart showing a misalignment correction procedure;

FIG. 21 is a diagram showing an example a test pattern;

FIG. 22 is a diagram showing a test patch and a dot arrangement in which no color misalignment occurs;

FIG. 23 is a diagram showing a test patch and a dot arrangement in which color misalignment has occurred;

FIG. 24 is a diagram showing the amount of misalignment between each cyan dot and the corresponding magenta dot; and

FIG. 25 is a table showing the relationship between the amount of color misalignment and the print element group used.

### DESCRIPTION OF THE EMBODIMENTS

An embodiment of the present invention will be described with reference to the drawings. In the present application, “printing” refers broadly to formation of an image, a pattern, or the like on a print medium regardless of whether or not the image, pattern, or the like is meaningful, or to processing of the print medium. Furthermore, the image, pattern, or the like may or may not be actualized so as to be visually perceivable by human beings.

Additionally, “print media” refer not only to common paper used for printing apparatuses but also broadly to materials such as cloths, plastic films, metal plates, glass, ceramics, woods, and leather which can receive ink.

Moreover, “ink” needs to be broadly interpreted as is the case with the definition of the “printing”. The “ink” refers to a liquid applied onto the print medium to allow formation of an image, a pattern, or the like, processing of the print medium, or treatment of the ink. The treatment of the ink may be, for example, solidification or insolubilization of a coloring agent in the ink applied to the print medium.

Moreover, a “print element” (hereinafter also referred to as a “nozzle”) refers collectively to an ink ejection port, a liquid passage that is in communication with the ink ejection port, and an element configured to generate energy utilized to eject ink.

In addition, the “printing apparatus” refers not only to a printer but also to a copier, a facsimile machine, a word processor, and other composite apparatuses which have a printing function.

### [Configuration of the Printing Apparatus]

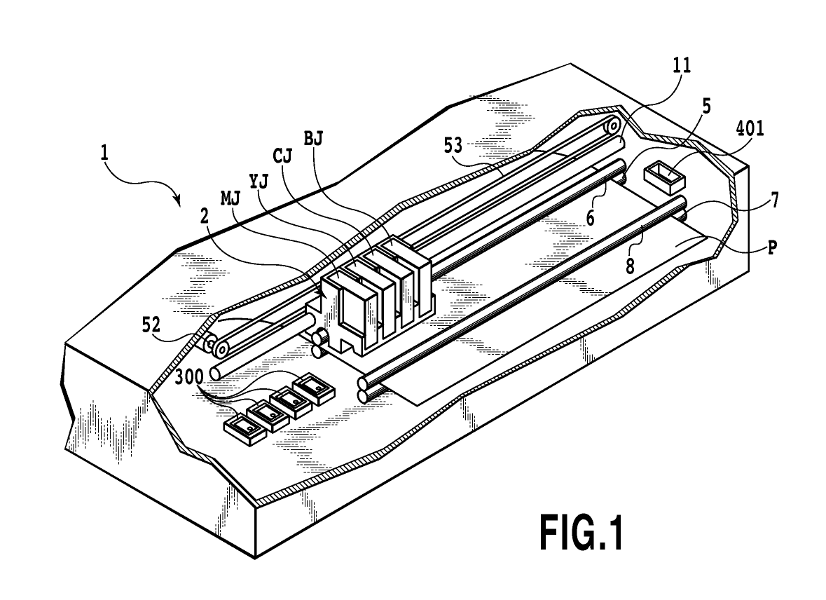

With reference to FIG. 1, an ink jet printing apparatus applied to the present embodiment will be described.

An ink jet printing apparatus 1 includes a plurality of ink jet cartridges (hereinafter referred to as cartridges) J. In the present embodiment, the ink jet printing apparatus 1 includes four cartridges J. The plurality of cartridges J are mounted in a carriage 2. Each of the cartridges J includes an ink tank in the upper part thereof, a print head in the lower part thereof, and a connector configured to receive signals allowing the print head to be driven.

Different types of ink with the respective colors, yellow, magenta, cyan, and black are accommodated in the corresponding ink tanks in the cartridges J. The carriage 2 includes a connector holder configured to transmit signals allowing the print heads in the cartridges J to be driven. The connector holder is electrically connected to each of the print heads. In the illustrated example, magenta ink M, yellow ink Y, cyan ink C, and black ink B are accommodated in the respective ink tanks in the cartridges J in this order from the left of the drawings.

Reference numeral 11 denotes a scan rail extending in a direction in which the print head is scanned (main scanning direction) to slidably support the carriage 2. Reference numeral 52 denotes a carriage motor. Reference numeral 53 denotes a driving belt configured to transmit a driving force of the carriage motor 52 required to reciprocate the carriage 2 in the main scanning direction. The position of the carriage 2 in the main scanning direction is detected by a linear encoder (for example, an optical linear encoder).

Reference numerals 5 and 6, 7 and 8 denote conveyance roller pairs arranged before and after a print position on a print medium and configured to convey the print medium sandwiched between the rollers. This conveyance direction corresponds to a sub-scanning direction orthogonal to the main scanning direction. Reference character P denotes a print medium. The print medium P is compressed against a guide surface of a platen (not shown in the drawings) configured to regulate a print surface of the print medium P so as to make the print surface flat.

The print heads in the cartridges J mounted in the carriage 2 project downward from the carriage 2 and lie between conveyance rollers 6 and 8. An ejection port formation surface of the print head in which ejection ports are formed is located parallel and opposite to the print medium P compressed against the guide surface of the platen (not shown in the drawings). A recovery unit is disposed on a home position side of the printing apparatus corresponding to the left side of FIG. 1.

In the recovery unit, reference numeral 300 denotes a cap unit provided in association with each of the four print heads in the respective cartridges J and configured to be able to elevate and lower. When the carriage 2 is in a home position, the cap unit 300 is joined to and caps the print head. The cap unit 300 thus prevents evaporation of ink in the ejection ports in the print head, thus preventing inappropriate ejections resulting from an increase in ink viscosity or evaporation and fixation of volatile components.

Furthermore, the inside of the cap unit 300 is in communication with a pump unit (not shown in the drawings). The pump unit generates a negative pressure as required. For example, when the print head has been brought into an inappropriate ejection state and the cap units 300 are thus to be joined to the print heads for suction recovery, the pump unit generates a negative pressure. Alternatively, when ink preliminarily ejected into the caps of the cap units 300 is idly sucked, the pump unit generates a negative pressure.

Reference numeral 901 denotes a preliminary ejection reception section provided opposite the home position across a printing operation area for the print medium P. In the preliminary ejection reception section 401, the print heads preliminarily eject ink. A blade formed of an elastic member may be provided on the recovery unit so as to wipe off droplets attached to the ejection port formation surface of the print head. Alternatively, to preclude unwanted substances from being pushed into the apparatus as a result of the wiping, preliminary ejection may be carried out after the wiping to stabilize the ejection state.

In the printing apparatus according to the present embodiment, a conveying drive motor configured to convey the print medium P is the same as a drive motor configured to operate the recovery unit.

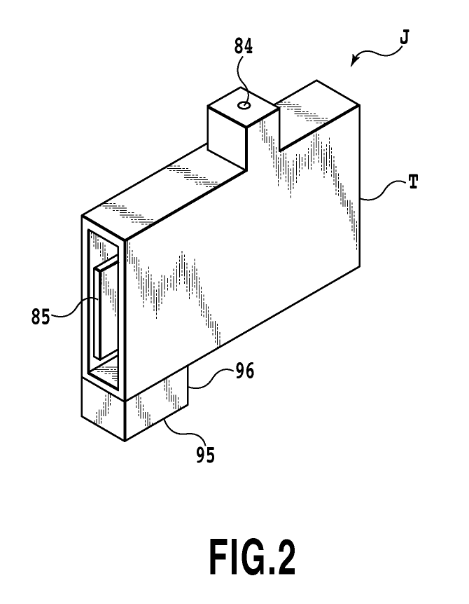

As shown in FIG. 2, the cartridge J includes an ink tank T in the upper part and a print head 96 in the lower part. An air hole 84 is formed at the top of the ink tank T. A head side connector 85 is positioned in juxtaposition with the ink tank T. The connector 85 receives, for example, a signal for allowing the print head 96 to be driven, and outputs an ink remaining amount sensing signal. The print head 96 includes an ejection port surface 95 with a plurality of ejection ports open in the bottom surface thereof. An electrothermal conversion member configured to generate thermal energy required eject ink is provided in each liquid passage portion of the pint head which is in communication with the corresponding ejection port.

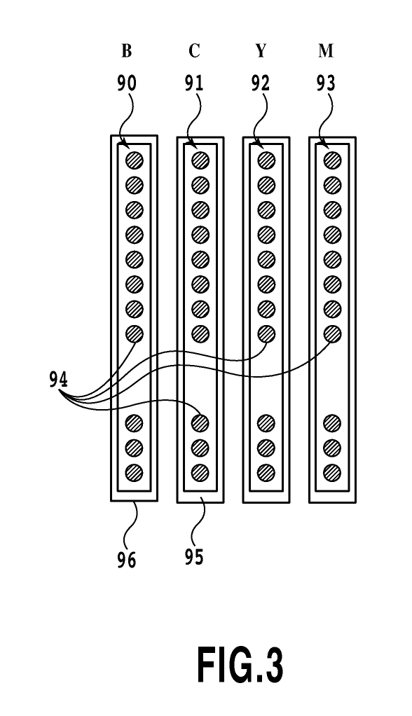

As shown in FIG. 3, a plurality of ink ejection ports 94 are arranged in the ink ejection port surface 95 of the print head 96. Sixty four ink ejection ports 94 are arranged in each of ink ejection port rows 90, 91, 92, and 93 in a line in the sub-scanning direction. Ink droplets in black B are ejected through the ink ejection port row 90. Ink droplets in cyan C are ejected through the ink ejection port row 91. Ink droplets in yellow Y are ejected through the ink ejection port row 92. Ink droplets in magenta M are ejected through the ink ejection port row 93.

The print head 96 may be configured such that for example, the plurality of ink ejection ports 94 are arranged in two lines in the sub-scanning direction so as to form each of the ink ejection port rows 90, 91, 92, and 93. Furthermore, the black ink ejection port row 90 may have more ink ejection ports 94 than the ink ejection port rows 91, 92, and 93 for the other colors.

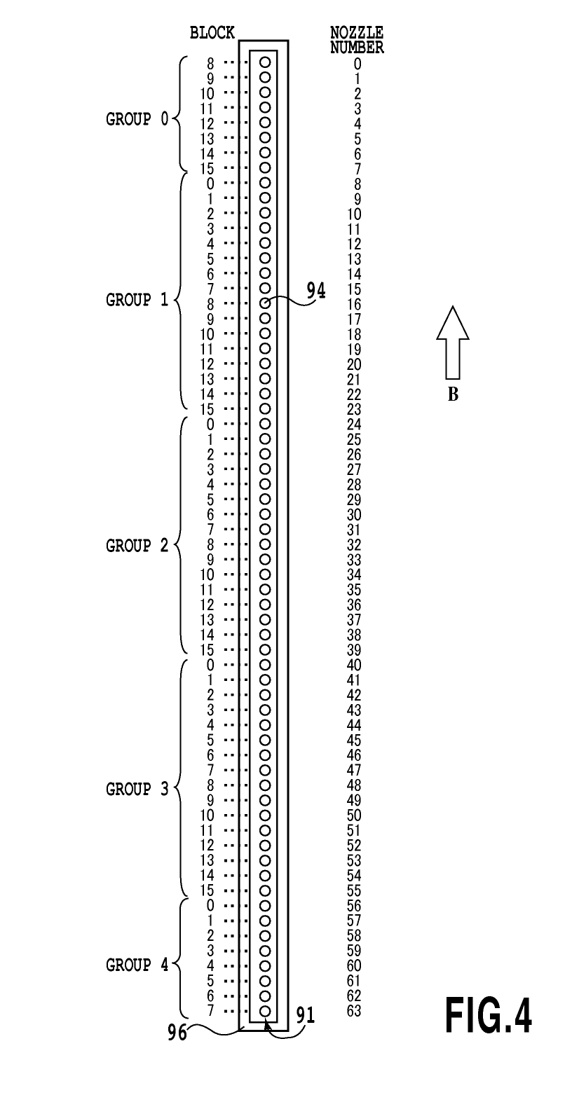

FIG. 4 shows the print head 96 including the ink ejection port row 91 with the 64 ink ejection ports 94. The print head 96 has a similar configuration for all the colors. Here, the cyan print head 96 will be described as a typical example.

The ink ejection ports 94, print elements, or nozzles in the upper part, in the figure, of the ink ejection port row 91 are positioned on the downstream side of the sub-scanning direction B. The ink ejection ports 94 are sequentially numbered upstream from 0, corresponding to the most downstream ink ejection port 94, to 63. The ink ejection ports with nozzle numbers 8 to 55 are reference or specified ink ejection ports. The ink ejection ports 94 with nozzle numbers 0 to 7 and 56 to 63 are what is called compensatory or preliminary ink ejection ports used for shifting the ink ejection ports used when color misalignment occurs in the sub-scanning direction. In this manner, the reference print element group used in the intermediate portion is sandwiched between compensatory print element groups positioned at the opposite ends of the ink ejection port row 91.

Every 16 of the ink ejection ports 99 with the nozzle numbers 8 to 55 are assigned to each of groups 1 to 3, starting with the smallest nozzle number. Furthermore, blocks 0 to 15 are sequentially assigned to the ink ejection ports in each group, starting with the smallest nozzle number. Furthermore, blocks 8 to 15 are assigned to the ink ejection ports 94 with the nozzle numbers 0 to 7. Blocks 0 to 7 are assigned to the ink ejection ports 94 with the nozzle numbers 56 to 63.

Thus, the 64 print elements are divided into 16 blocks. In each block, any of the print elements are selected and driven in a time division manner to print an image. In the description below, an example is taken in which an image is printed using the ink ejection ports 99 in the yellow ink ejection port row 92 similarly configured to the cyan ink ejection port row 91.

### [Configuration of a Control Circuit for the Printing Apparatus]

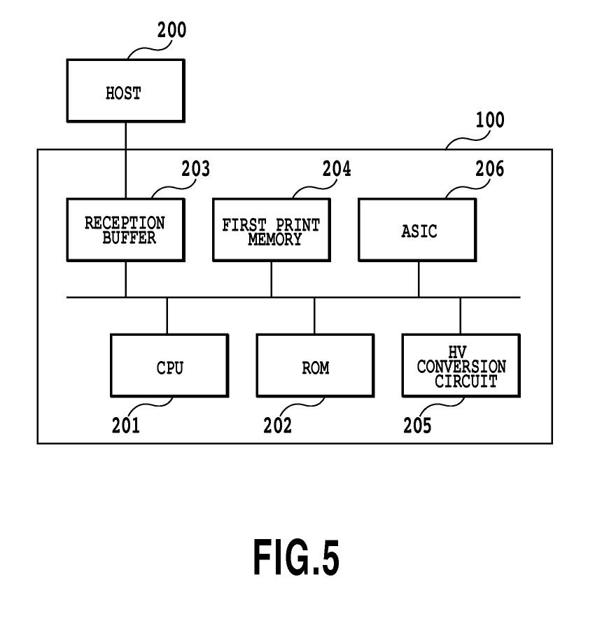

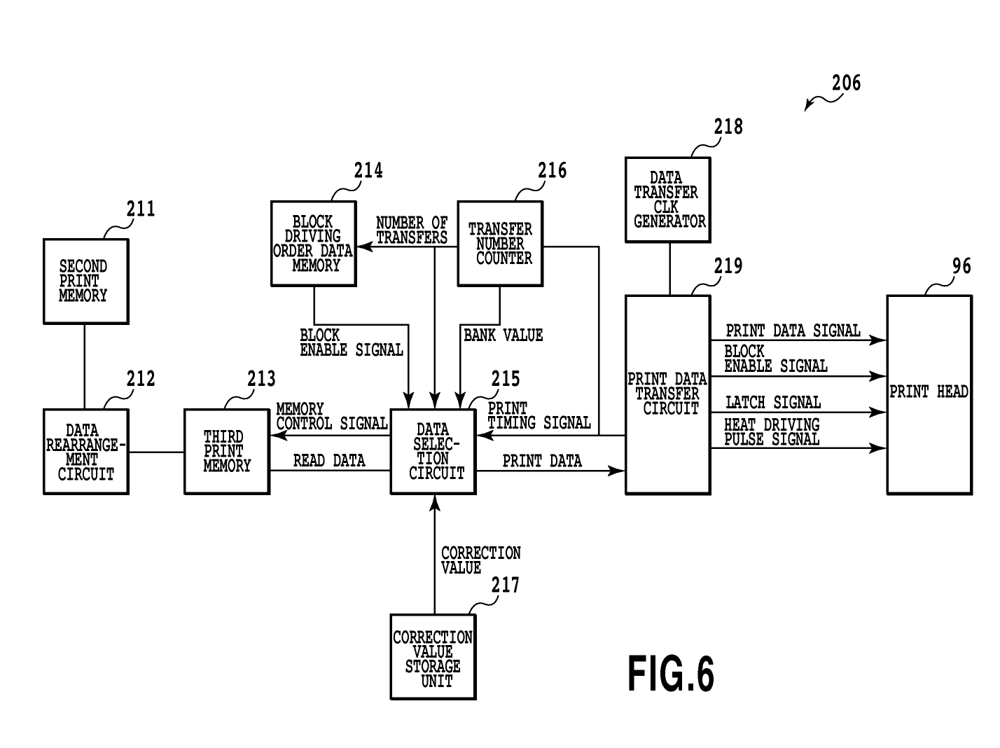

FIG. 5 is a block diagram showing the configuration of a control circuit 100 for the ink jet printing apparatus 1. In FIG. 5, reference numeral 201 denotes a CPU, and reference numeral 202 denotes a ROM configured to store control programs executed by the CPU 201. Print data in units of rasters received from a host 200 is first stored in a reception buffer 203. The print data stored in the reception buffer 203 is compressed to reduce the amount of data transmitted by the host 200. The print data is expanded and then stored in a first print memory 209. The print data stored in the first print memory 204 is subjected to an HV (Horizontal-Vertical) conversion process by an HV conversion circuit 205. The resultant data is stored in a second print memory 211 (see FIG. 6). That is, the print data stored in the first print memory 204 in the raster direction is rearranged, by the HV conversion process, in a column direction in accordance with the arrangement of the print elements. The resultant data is stored in the second print memory 211.

FIG. 6 is an internal block diagram of an ASIC 206 provided in the control circuit 100. Here, the basic ASIC 206 will be described as a referential example. The ASIC 206 according to the present embodiment will be separately described below.

A configuration for sequentially driving the print elements in a time division manner will be described. A data rearrangement circuit 212 is configured to rearrange print data. The circuit 212 writes the print data held in the second print memory 211 to a third print memory 213 so that 7-bit print data for each block is simultaneously printed. The print data held in the second print memory 211 is associated with the 64 print elements.

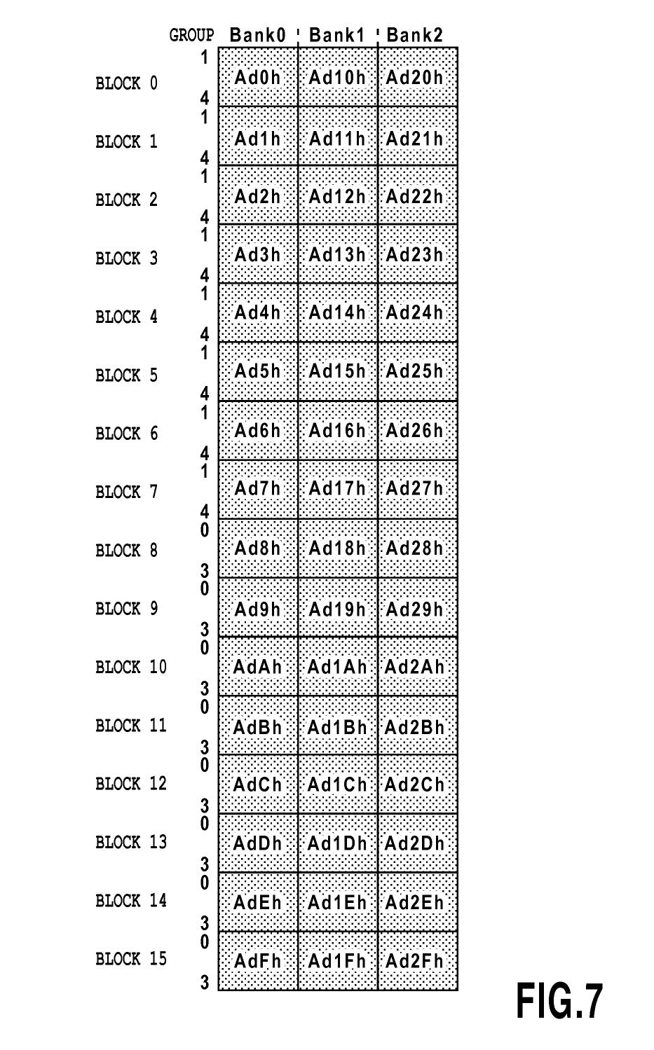

FIG. 7 is a diagram showing the configuration of the third print memory 213. In FIG. 7, for example, “Ad” in “Ad0h” means an address, “0” means an address number, and “h” means a hexadecimal number. Furthermore, block numbers are shown at the left end of FIG. 7. Moreover, in FIG. 7, for example, “group 1 4” shown to the left of “Ad0h” means that a block 0 belongs to groups 1 to 4 (not belong to a group 0) as is understood with reference to FIG. 4.

In the third memory 213, the print data in blocks 0 to 15 is held in order at addresses 0 (Ad0h) to F (AdFh). The data of the block 0 in the groups 1 to 4 is held at the address 0. Similarly, the data of the block 1 in the groups 1 to 9 is held at address 1. The data of the block 14 in the groups 0 to 3 is held at the address E. Similarly, the data of the block 15 in the groups 0 to 3 is held at the address F.

Furthermore, in order to make a write operation and a read operation exclusive from each other, three banks each corresponding to 16 blocks of data are provided in the third print memory.

When a bank 0 is used for write, read is carried out on banks 1 and 2. Furthermore, when the bank 1 is used for write, read is carried out on the banks 2 and 0. When the bank 2 is used for write, read is carried out on the banks 0 and 1.

With reference to FIG. 6, a transfer number counter 216 is a counter circuit configured to count the number of print timing signals generated based on output signals from a linear encoder. The count in the transfer number counter 216 is incremented for each print timing signal. The transfer number counter counts from 0 to 15 and then returns to 0. Moreover, the transfer number counter 216 counts a bank value in the third print memory. Upon making 16 counts, the transfer number counter increments the bank value by +1.

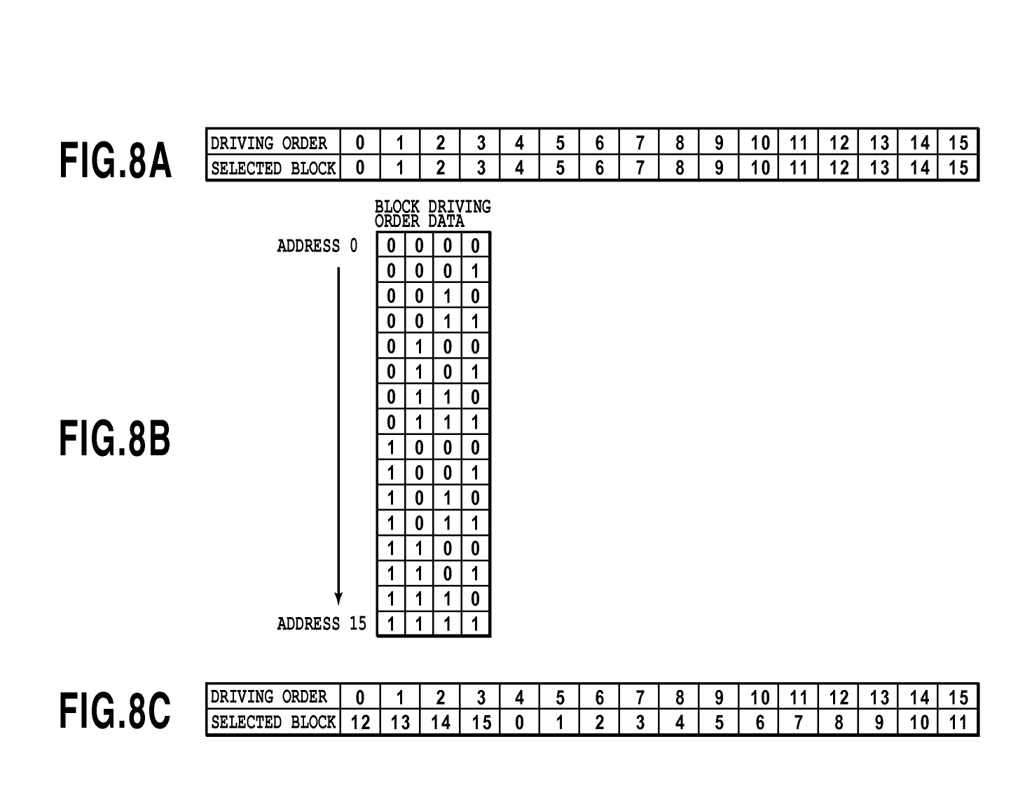

In a block driving order data memory 219, the order in which the print elements in the 16 blocks with the block numbers 0 to 15 are driven is recorded at the addresses 0 to 15. For example, if the print elements are sequentially driven starting with the block number 0 as shown in FIG. 8A, the block numbers are stored at the addresses 0 to 15 in order of 0, 1,2, . . . , 15.

A print data transfer circuit 219 increments the count in the transfer number circuit 216, for example, using, as a trigger, a print timing signal generated based on an output signal from the linear encoder. A data selection circuit 215 uses the print timing signal as a start point to read, from the print memory 213, print data corresponding to the value in the block driving source data memory 219 and the bank value counted by the transfer number counter 216. The data selection circuit 215 then corrects the print data in accordance with a correction value held in a correction value storage unit 217. The data selection circuit 215 then transfers the data to the print head 96 in synchronism with a data transfer CLK (HD_CLK) signal generated by a data transfer CLK generator 218.

FIG. 8B shows an example of block driving order data written to the addresses 0 to 15 in the block driving order data memory 214. Block driving order data indicative of the blocks 0 and 1 are stored at the addresses 0 and 1 in the block driving order data memory 219. Similarly, block driving order data indicative of the blocks 2 to 15 are stored at the addresses 2 and 15 in the block driving order data memory 214. Thus, the blocks are driven in order of 0, 1, 2, . . . , 15.

The data selection circuit 215 (see FIG. 6) reads block driving order data 0000 (a numerical value indicative of the block 0) from the address 0 in the block driving order data memory 214 as a block enable signal, using the print timing signal as a trigger. The data selection circuit 215 then reads the print data corresponding to the block driving order data 0000 from the third memory 213. The data selection circuit 215 then transfers the print data to the print head 96.

Similarly, upon receiving the next print timing signal, the data selection circuit 215 reads block driving order data 0001 (a numerical value indicative of the block 1) from the address 1 in the block driving order data memory 214 as a block enable signal, using the print timing signal as a trigger. The data selection circuit 215 then reads the print data corresponding to the block driving order data 0001 from the third memory 213. The data selection circuit 215 then transfers the print data to the print head 96.

Thus, the data selection circuit 215 sequentially reads the block driving order data set at the addresses 0 to 15 in the block driving order data memory 214. Then, the data selection circuit 215 reads the print data corresponding to the block driving order data from the third print memory 213, and then transfers the print data to the print head 96.

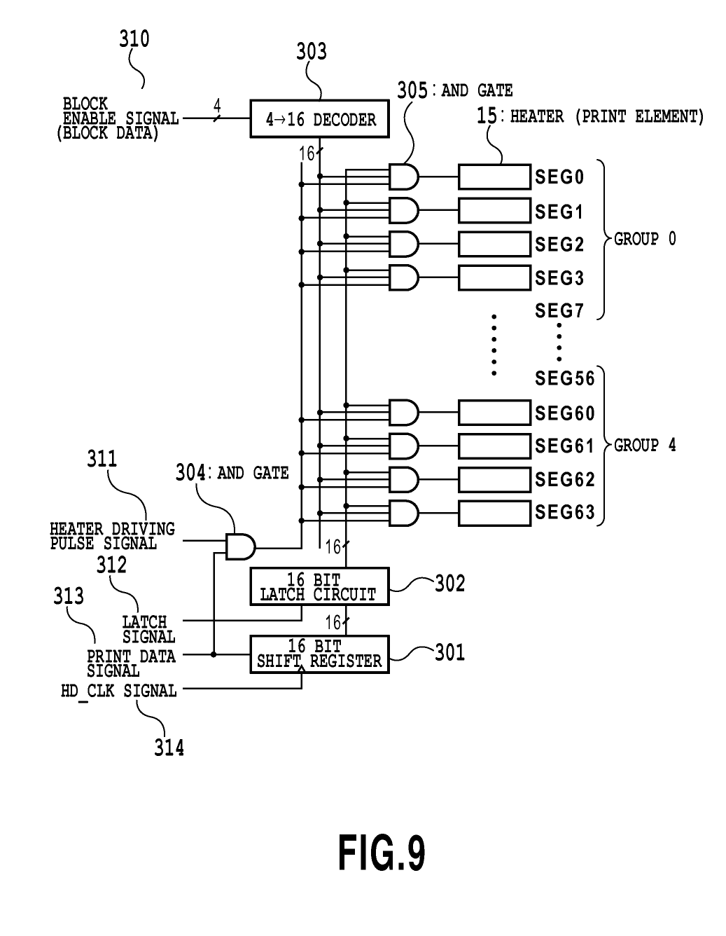

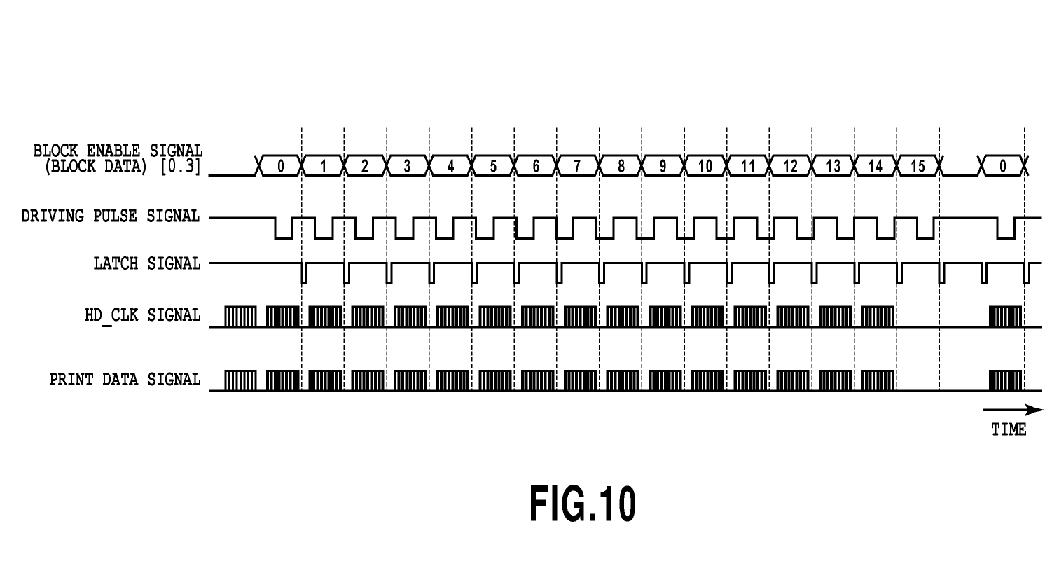

FIG. 9 shows a driving circuit configured to drive the print head 96. FIG. 10 shows timings for signals. A print data signal 313 is serially transferred to the print head 96 in accordance with the timing for an HD_CLK signal 314. The print data signal 313 is received by a 16-bit shift register 301. Thereafter, the print data received and aligned in the shift register 301 is latched in a 16-bit latch circuit 302 at the timing for a rinsing edge for the latch signal 312. A specification for a block is transmitted to a decoder 303 as four block enable signals 310. The decoder 303 then converts the four block enable signals 310 into 16 block selection signals corresponding to the 16 blocks. As a result, the corresponding print elements 15 are selected.

A block selection signal from the decoder 303, a print data signal from the latch circuit 302, a heater driving pulse signal 311 are input to an AND gate 305. Thus, only the print elements 15 selected by the block section signal and having print data are driven for a time length indicated by the heater driving pulse signal 311. The print elements 15 eject ink droplets.

FIG. 10 shows the driving timing for the block enable signal 310. The block enable signal 310 can be generated based on the block driving order data stored in the block driving order data memory 214. As shown by the block enable signal 310 in FIG. 10, the block driving order generated by the block driving order data memory 214 is set to specify the 16 blocks in order starting with the block 0 and ending with the block 15. Thus, during one-way printing and forward scan printing in two-way printing, the block enable signal 310, indicating driving timings, allows the print head 96 to drive the blocks in order of 0, 1, 2, . . . , 15. The block enable signal 310 is generated to specify timings for the blocks corresponding to equal time intervals during one period.

### [Correction of Misalignment in the Sub-Scanning Direction]

First, print head misalignment (color misalignment) in the sub-scanning direction will be described in brief.

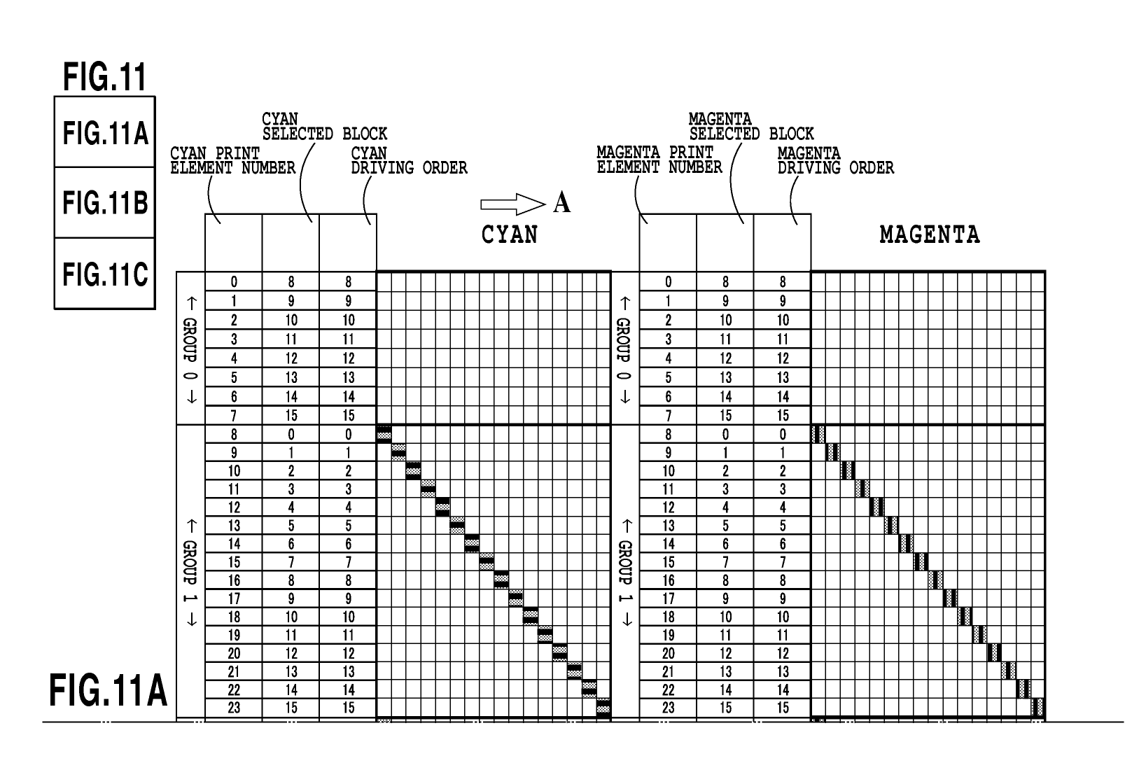

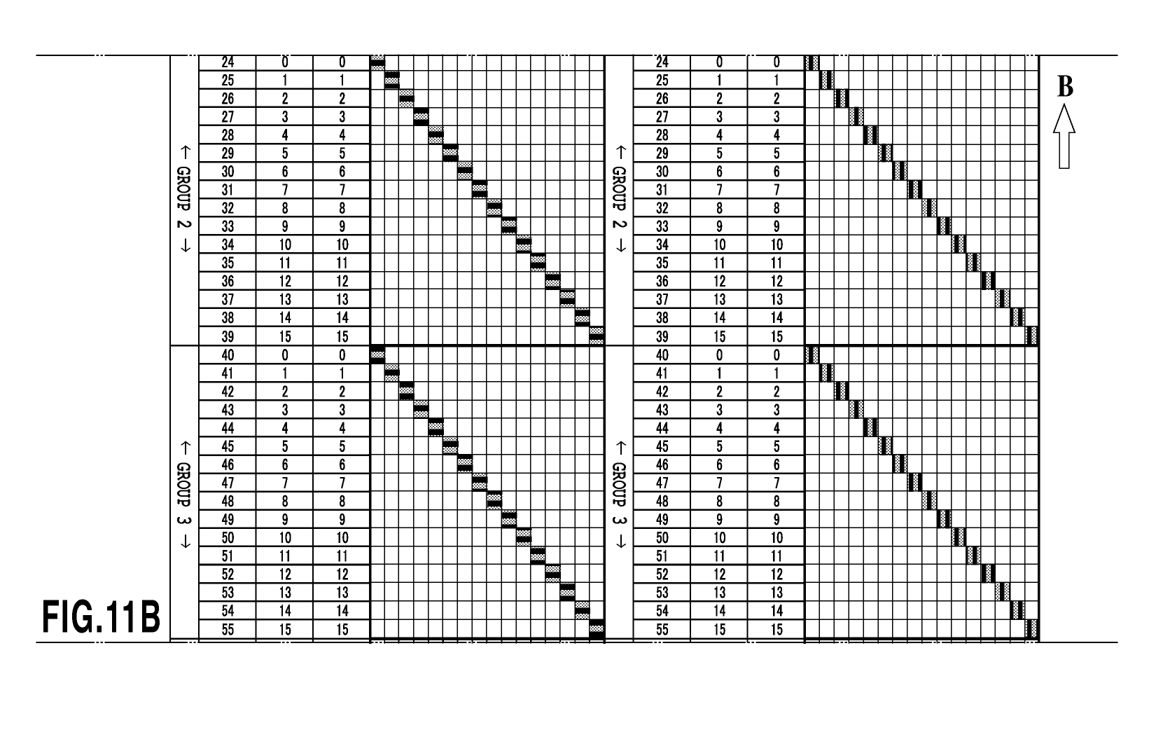

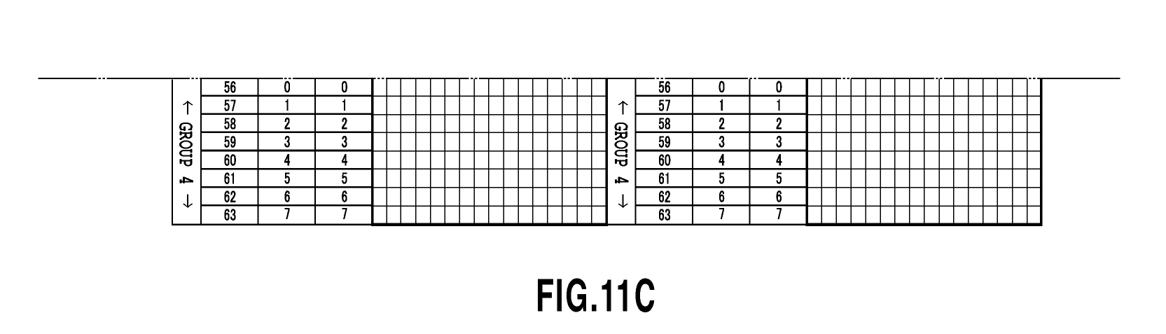

FIGS. 11A-11C show the arrangement of dots formed on a print medium when the plurality of print heads are ideally installed in the ink jet printing apparatus and when no print head (print element array) misalignment, that is, no color misalignment, occurs in the sub-scanning direction. In this case, the print heads are installed in the ink jet printing apparatus parallel to the sub-scanning direction, shown by arrow B. The print elements are also arranged along the sub-scanning direction. Furthermore, the pint heads print the print medium by moving over the print medium from left to right along the main scanning direction, shown by arrow A. Additionally, the print medium is conveyed from the bottom to top of the figure in the sub-scanning direction, shown by arrow B. The top of the figure corresponds to the downstream side of the sub-scanning direction. The bottom of the figure corresponds to the upstream side of the sub-scanning direction.

As already described with reference to FIG. 4, the 69 ink ejection ports, that is, the 64 print elements, are divided into the three groups 1 to 3 each including 16 print elements and the two groups 0 and 4 each including 8 print elements. The print elements in each group are assigned to the different blocks. Sets each of the print elements belonging to the same block are sequentially driven at different timings.

In the groups 1 to 3, the blocks 0 to 15 are assigned to the print elements in each group starting with the most downstream print element in the sub-scanning direction. In the group 0, the blocks 8 to 15 are assigned to the print elements starting with the most downstream print element in the sub-scanning direction. In the group 4, the blocks 0 to 7 are assigned to the print elements starting with the most downstream print element in the sub-scanning direction. The print elements are driven in order of the blocks 0, 1, 2, . . . , 15 during one period in accordance with the block driving order based on FIGS. 8A and 8B.

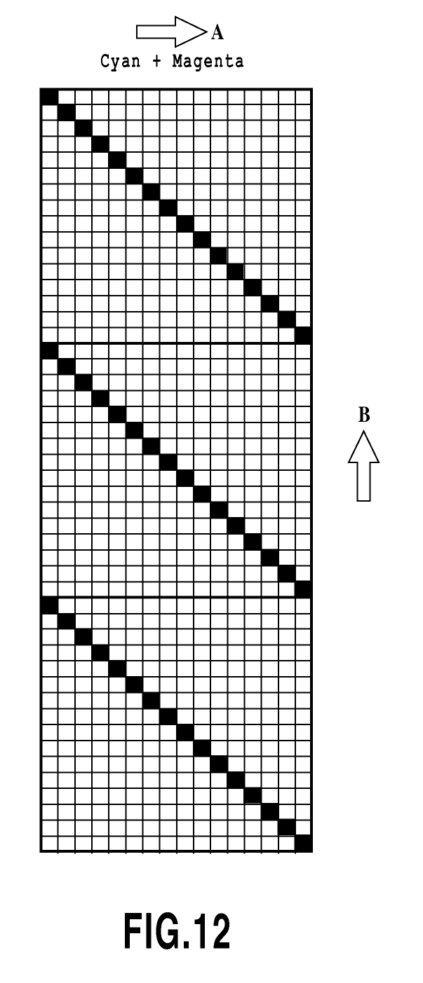

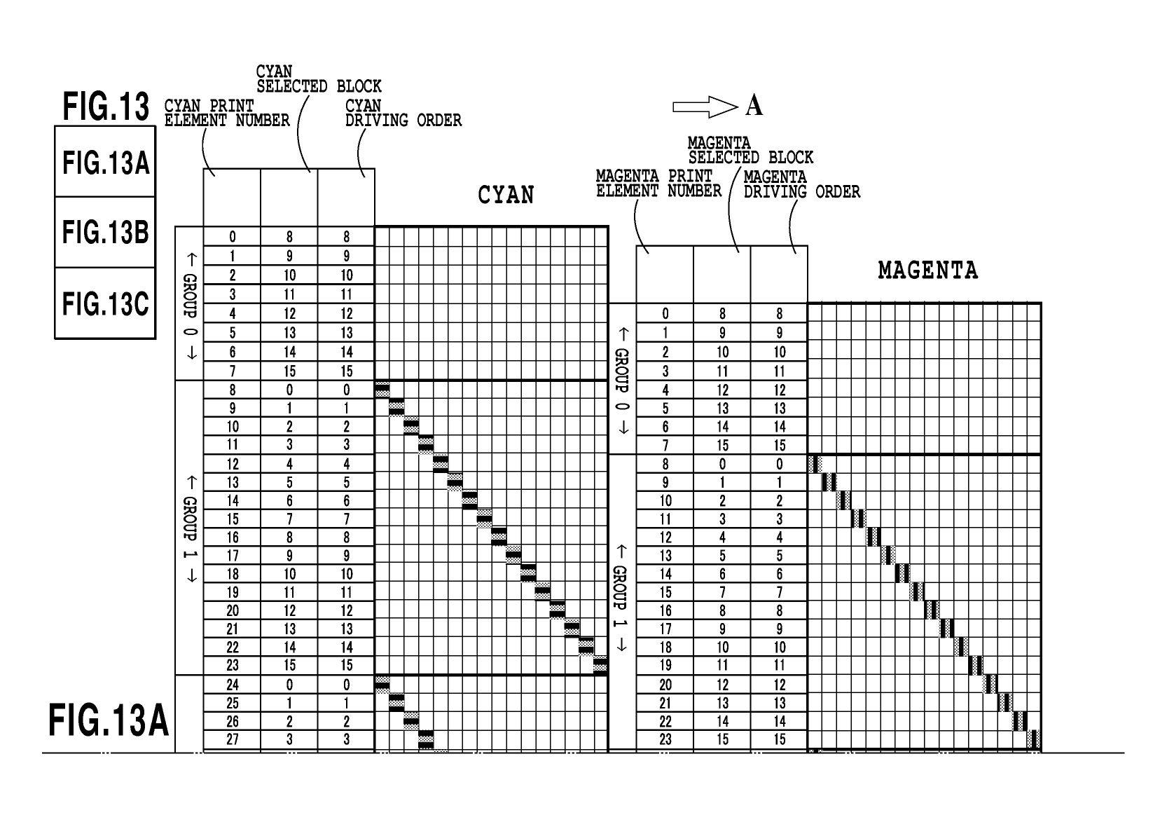

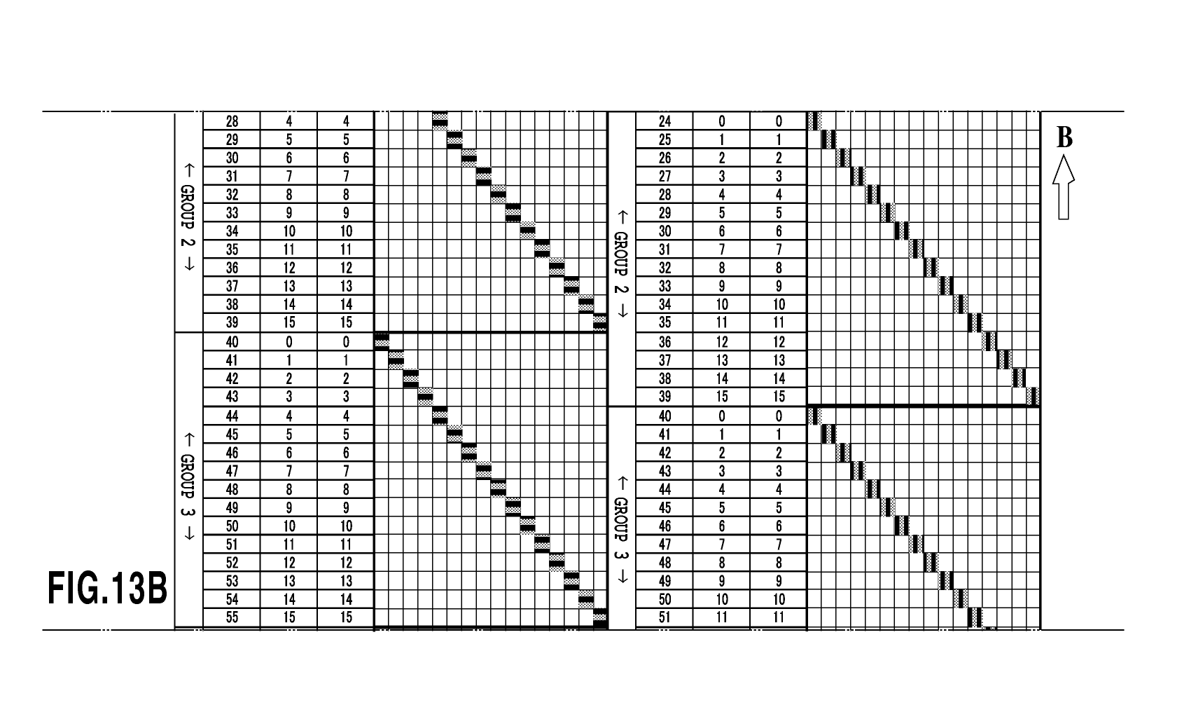

If no print head (print element array) misalignment occurs in the sub-scanning direction, dots formed by driving the blocks 0 to 15 of print elements during one period are formed at the ideal positions as shown in FIG. 12. Thus, an image with high print quality can be obtained. That is, in this example, each cyan dot and the corresponding magenta dot are intended to be printed at the same position. If no color misalignment occurs in the sub-scanning direction, each cyan dot and the corresponding magenta dot are intended to be printed at the same position as shown in FIG. 12.

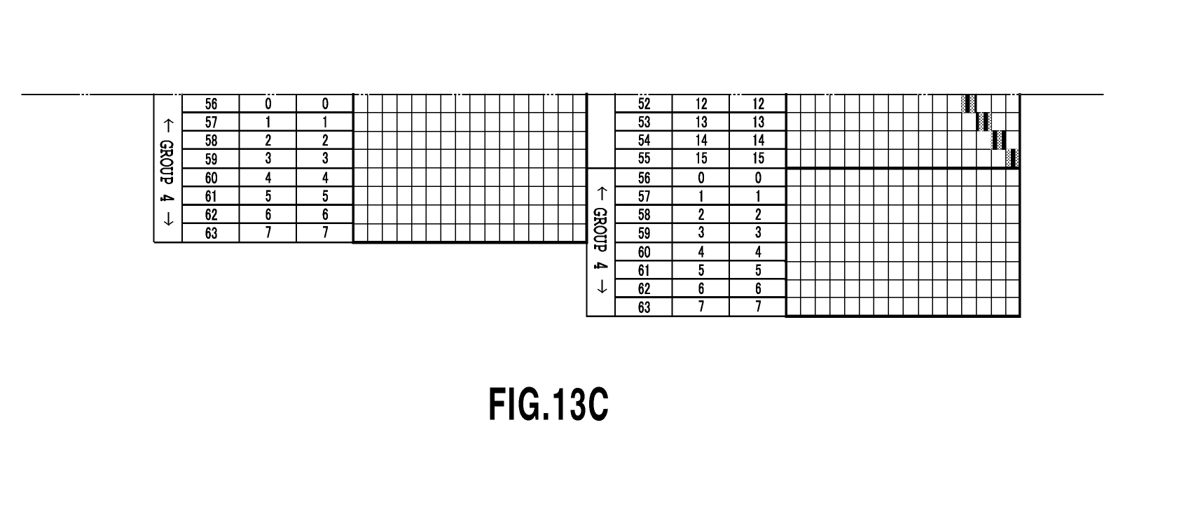

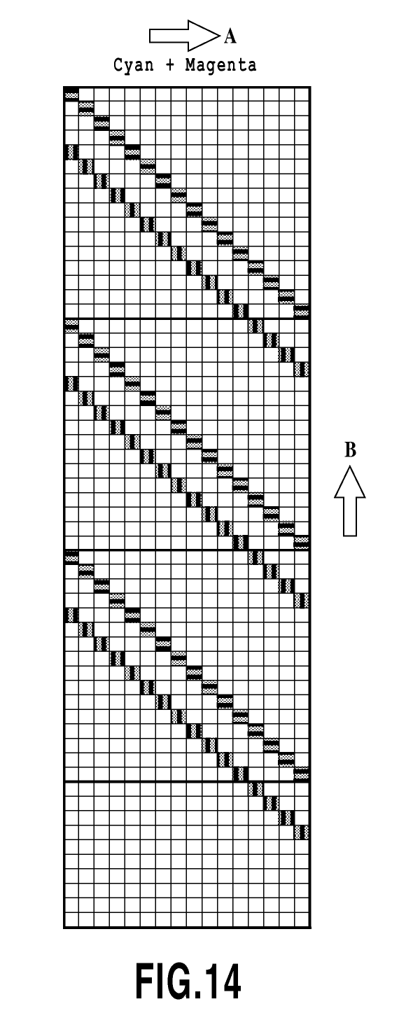

In contrast, FIGS. 13A-13C and FIG. 14 show a dot arrangement obtained when color misalignment corresponding to four pixels has occurred in the sub-scanning direction. Owing to the color misalignment, each magenta dot has failed to be printed at the same position as that of the corresponding cyan dot. This has resulted in degradation of image quality such as a variation in color or an inappropriate sense of granularity.

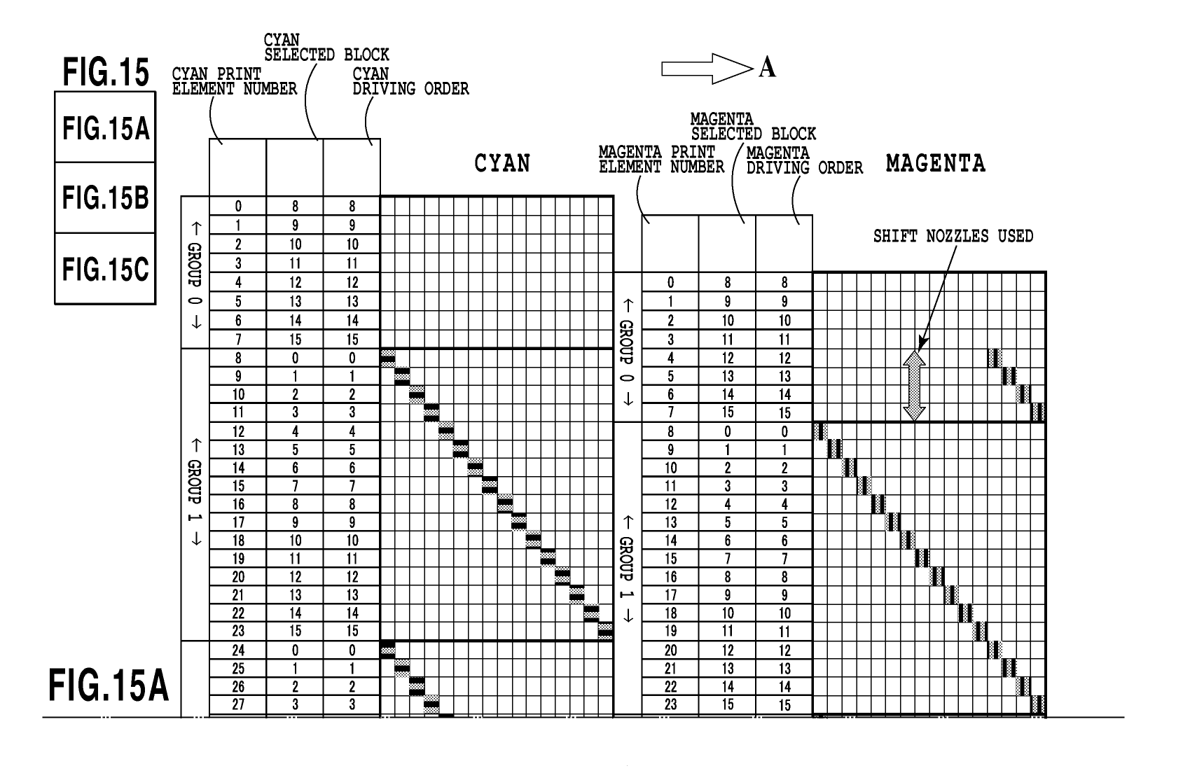

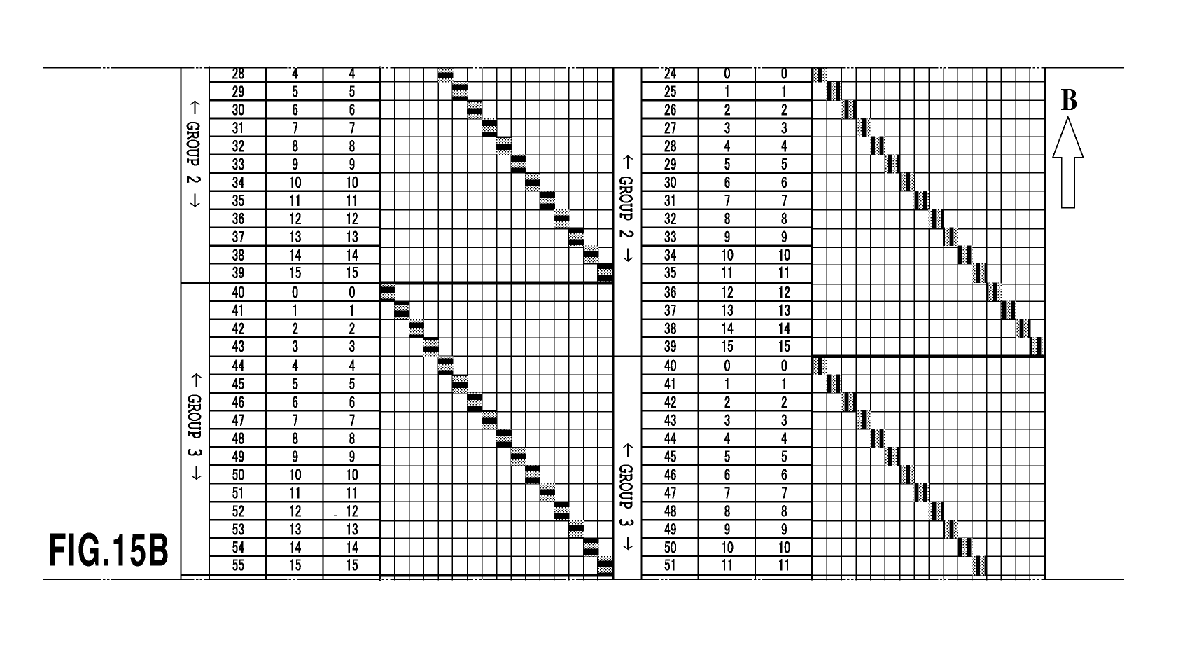

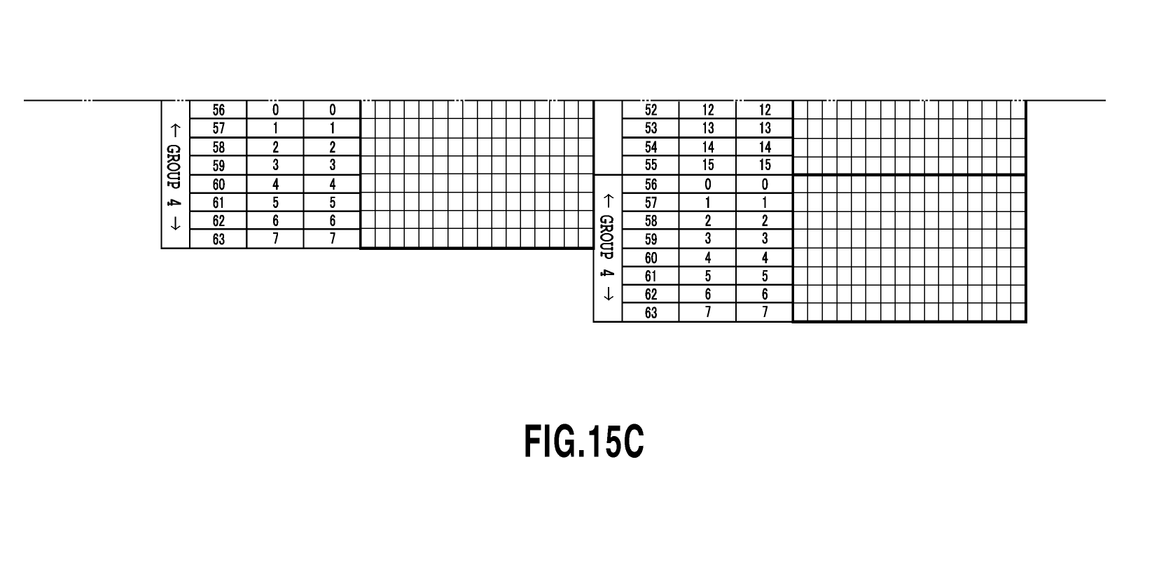

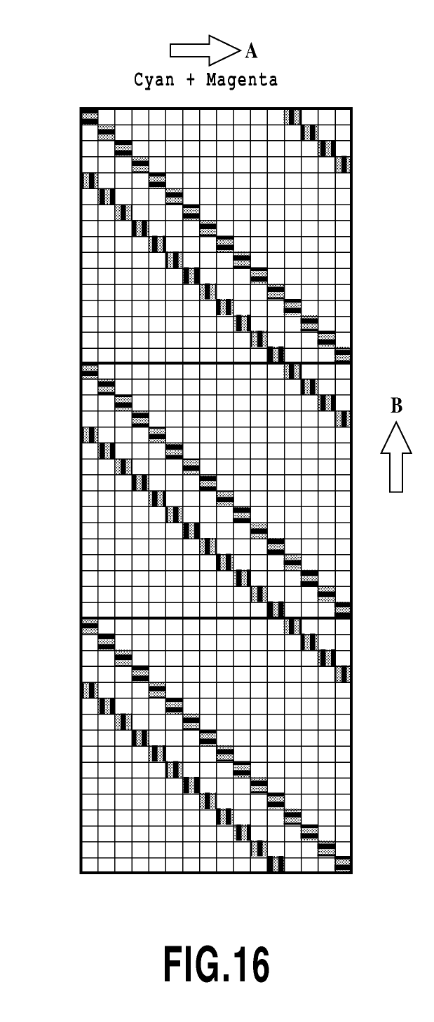

In contrast, FIGS. 15A-15C and FIG. 16 show a dot arrangement obtained when the print element group used for magenta is changed from 8 to 55, to 4 to 51. As seen from a comparison between FIG. 12 and FIG. 16, the image quality cannot be improved simply by shifting the print element group used.

This is because no change is made to the block driving order in which the blocks are driven in order of 0, 1, 2, . . . , 15 in a time division manner. That is, even if the print element group used is shifted as shown in FIGS. 15A-15C, the first print elements driven are those which belong to the block 0 and having the print element numbers 8, 24, and 40. Thus, printing still starts with the print element numbers 8, 24, and 40, which are misaligned with the corresponding cyan dots by four dots. Then, the print elements misaligned with the cyan dots by four pixels are sequentially used for printing. Hence, no correction is made to the misalignment of each magenta dot with the corresponding cyan dot. The image quality remains degraded.

Thus, in the present embodiment, the print element group used by the magenta print head is shifted, and the block driving order in the magenta print head is changed. This eliminates the misalignment of the magenta dots with the cyan dots, allowing the print quality to be improved.

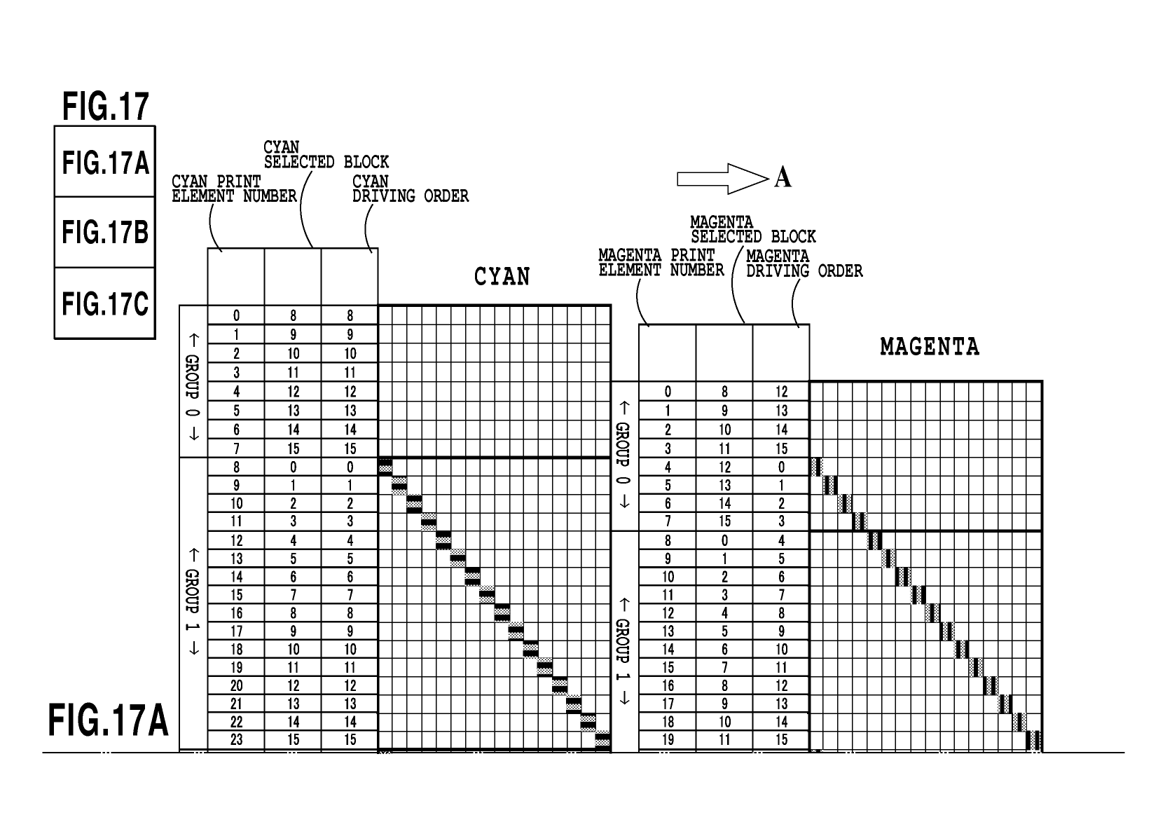

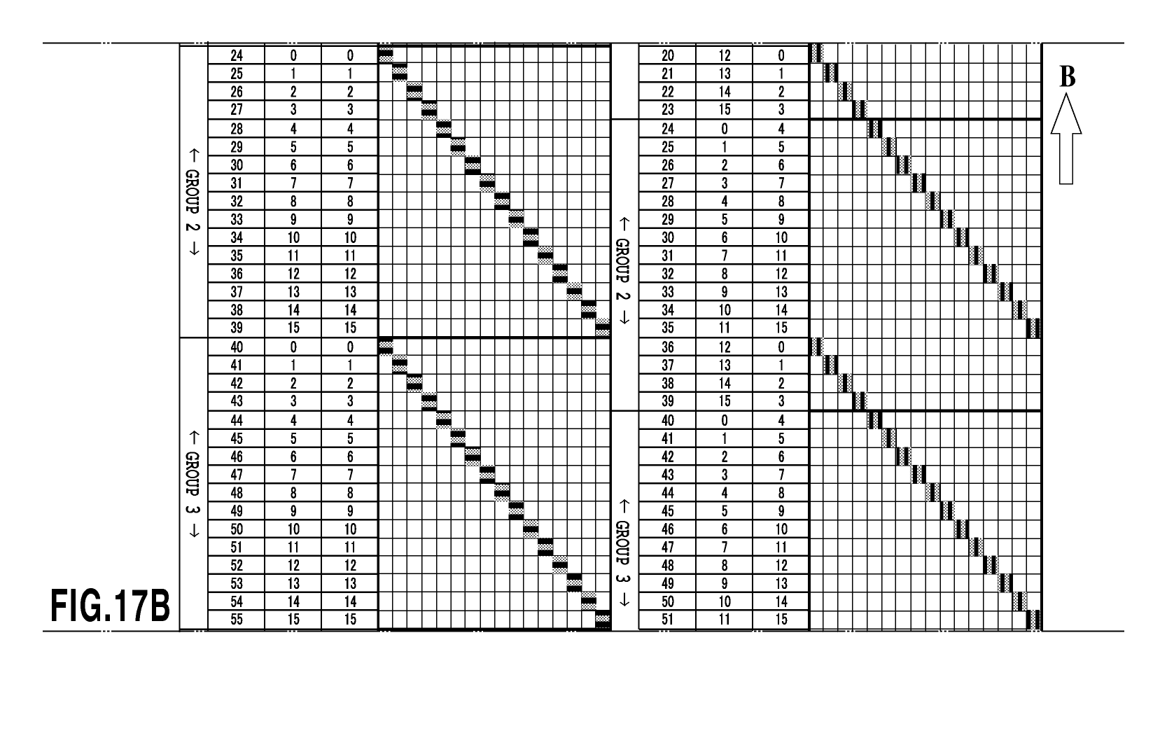

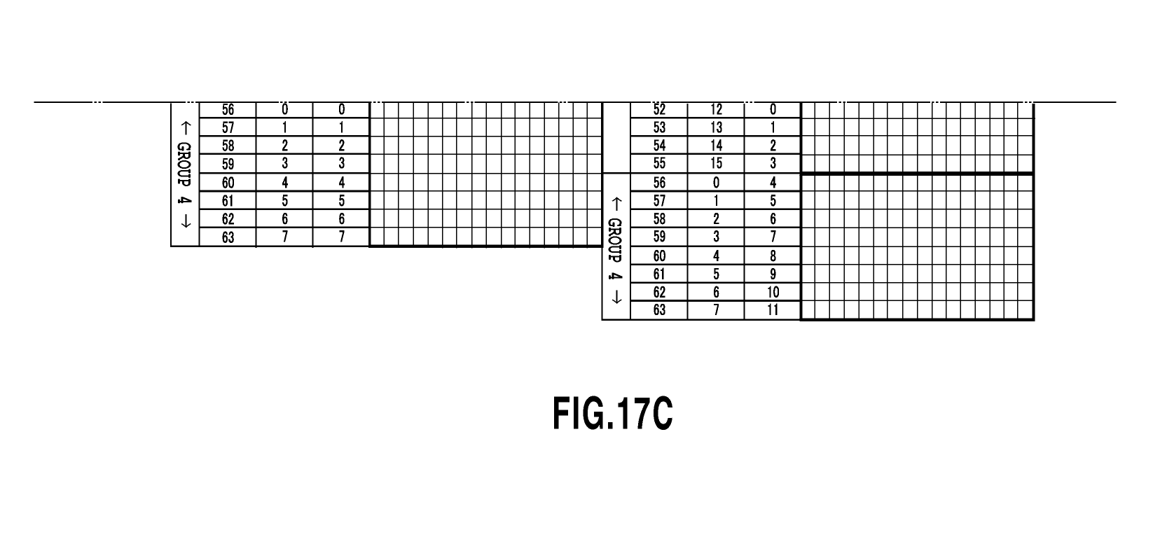

That is, as shown in FIGS. 17A-17C, the print element group used for magenta is changed from 8 to 55, to 4 to 51. Moreover, the block driving order in the magenta print head is changed by four blocks from 0→1→2→3→4→5→6→7→8→9→10→11→12→13→14→15 to 12→13→14→15−0→1→2→3→4→5→6→7→8→9→10→11.

This allows each cyan dot and the corresponding magenta dot to be printed at the same position as shown in FIG. 12. This enables prevention or inhibition of degradation of the print quality such as a variation in color or an inappropriate sense of granularity.

In the above description, the two colors, cyan and magenta, have been taken as an example. However, the present invention is application to a combination of colors different from cyan and magenta or a combination of at least three colors. For example, to eliminate misalignment among three ink colors, a particular one of the colors may be used as a reference to make corrections similar to those described above on the other two colors.

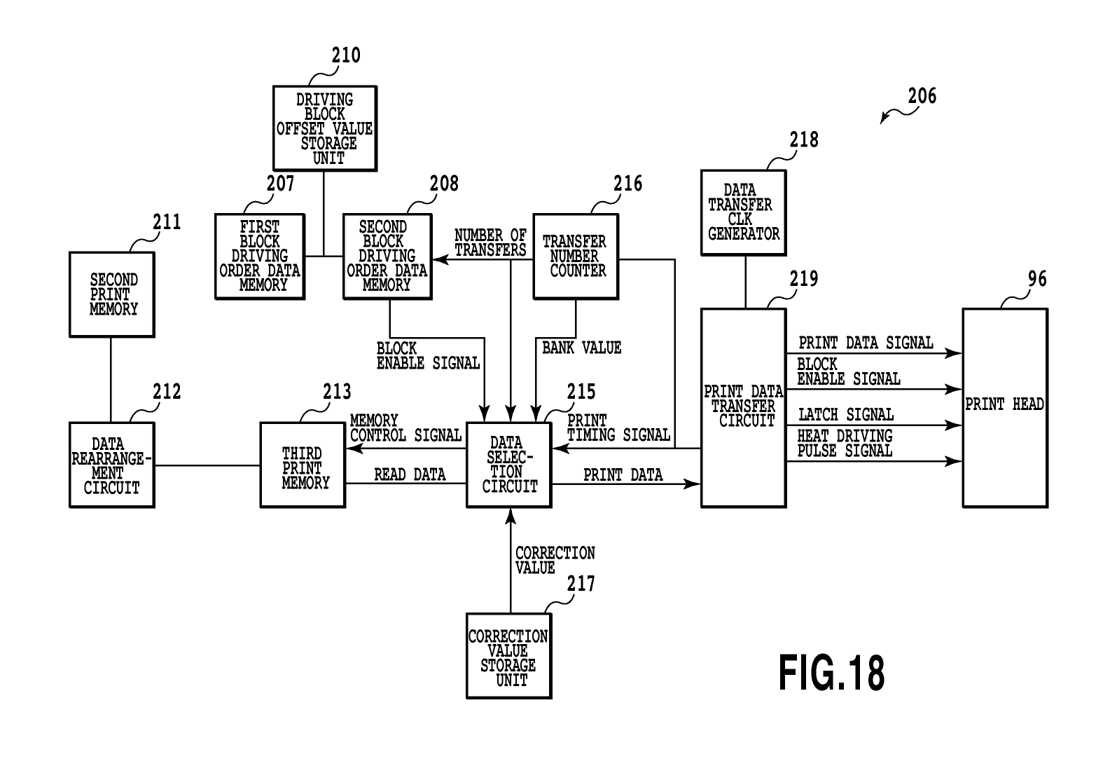

Specifically, the above-described change of block driving order is carried out as follows. FIG. 18 is an internal block diagram of an ASIC 206 according to the present embodiment. The ASIC 206 according to the present embodiment is the same as the ASIC 206 in the referential example in FIG. 6 except that the block driving order data memory 219 is replaced with a first block driving order data memory 207, a second block driving order data memory 208, and a driving block offset value storage unit (storage memory) 210. As is the case with the block driving order data memory 214 in the referential example shown in FIG. 6, in the first block driving order data memory 207, block driving order data on the blocks 0 to 15 are stored at the addresses 0 to 15, respectively. That is, such reference block driving order data is stored as allows driving of the blocks in the reference block driving order, namely, 0→1→2→3→4→5→6→7→8→9→10→11→12→13→14→15.

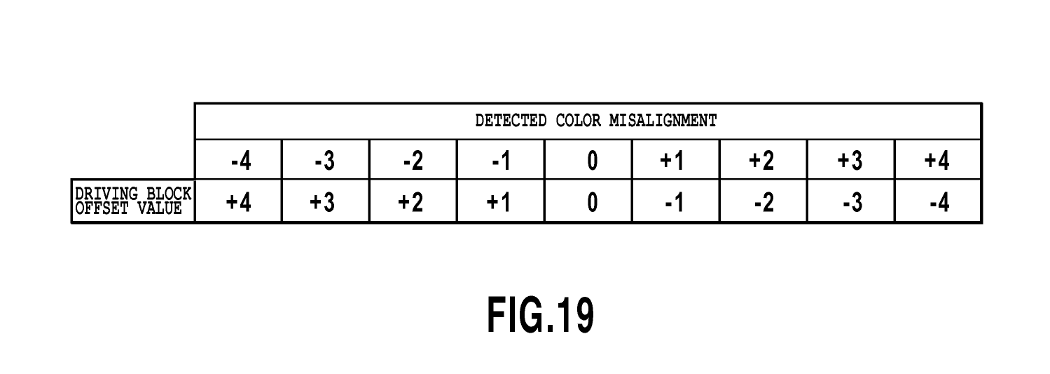

In the driving block offset value storage unit 210, the relationship between the color misalignment amount and a driving block offset value is pre-stored in table form as shown in FIG. 19. Here, the color misalignment value detected by a method described below is “÷4”. Thus, a driving block offset value of −4 is acquired in accordance with the table.

The block driving order data stored in the first block driving order data memory 207 are rearranged based on the driving block offset value acquired from the driving block offset value storage unit 210. The block driving order data is stored in the second block driving order data memory 208. Then, the print elements are driven in order for every block in accordance with the block driving order data stored in the second block driving order data memory 208.

If the driving block offset value is zero, the block driving order data stored at the respective addresses in the first block driving order data memory 207 are stored at the same addresses in the second block driving order data memory 208. Thus, the print elements in the print head 96 are driven in order of 0, 1, 2, . . . , 15 as shown in FIG. 8A.

On the other hand, if the driving block offset value is −4, the block driving order data stored at the respective addresses in the first block driving order data memory 207 are stored in the second block driving order data memory 208 with the addresses shifted backward by four. For example, the block data in the block 12 is stored at the address 0. The block data in the block 13 is stored at the address 1. The block data in the block 0 is stored at the address 4. The block data in the block 1 is stored at the address 5. In this manner, the relationship between the addresses in the first block driving order data memory 207 and the block driving order data is changed so as to change the driving order of the print elements to the blocks 12→13→14→15→0→1→2→ . . . →11 as shown in FIG. 8C. This also applies to the other driving offset values. That is, the relationship between the addresses in the first block driving order data memory 207 and the block driving order data is changed to change the block driving order of the print elements.

Misalignment correction control according to the present embodiment will be described below.

Any method may be used to detect information on color misalignment, that is, a color misalignment amount. Here, by way of example, an optical sensor is used to detect the color misalignment amount. The optical sensor measures the optical characteristics of a test patch printed (described below) on a print medium. For example, the optical sensor can be mounted on the carriage 2 opposite the print medium and moved in the main scanning direction.

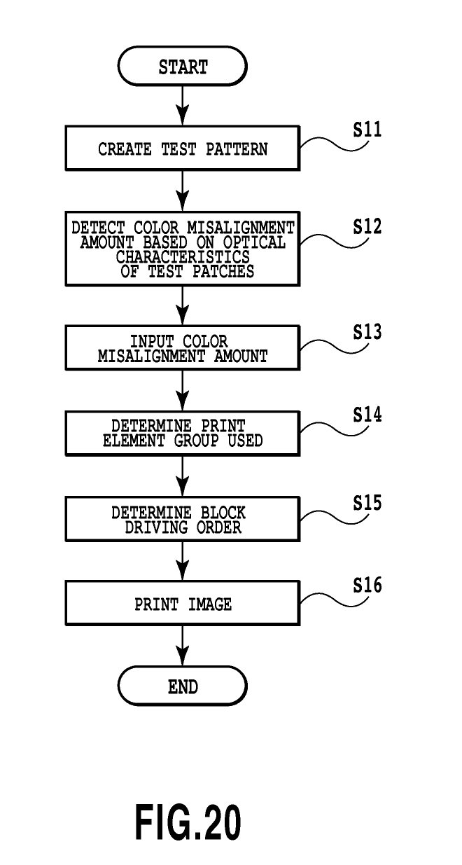

FIG. 20 shows the procedure of misalignment correction control. First, in step S11, a test pattern is created to detect the color misalignment amount in the sub-scanning direction. A plurality of test patches are printed on the print medium by gradually changing the print element group used by at least one print head and the block driving order with respect to corresponding reference values. The differences in optical characteristics among the test patches can be utilized to acquire the color misalignment value.

Then, in step S12, the optical sensor is used to measure the optical characteristics (for example, reflective optical density) of the test patches to detect or acquire the color misalignment amount in the sub-scanning direction.

In step S13, the detected color misalignment amount is input to the correction value storage unit 217 and the driving block offset value storage unit 210 (FIG. 18).

In step S14, based on the detected color misalignment amount, the print element group used is finally determined in accordance with a table (described below) pre-stored in the correction value storage unit 217.

In step S15, in accordance with the table (FIG. 19) pre-stored in the driving block offset correction value storage unit 210, a driving block offset value corresponding to the detected color misalignment amount is read. Then, based on the read driving block offset value, the final block driving order is determined in accordance with the above-described method

In step S16, the determined print element group and block driving order are used to print an image on a print medium.

Now, the creation of a test pattern in step S11 and the detection of color misalignment information in step S12 will be described in further detail.

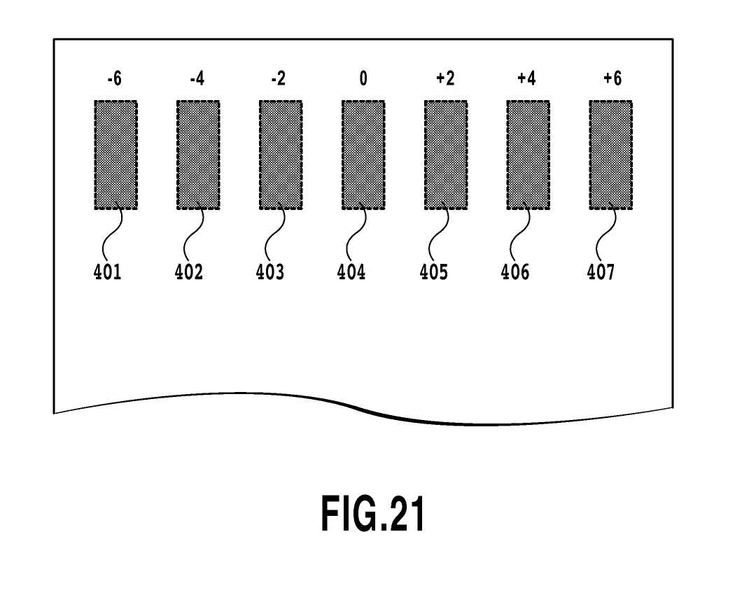

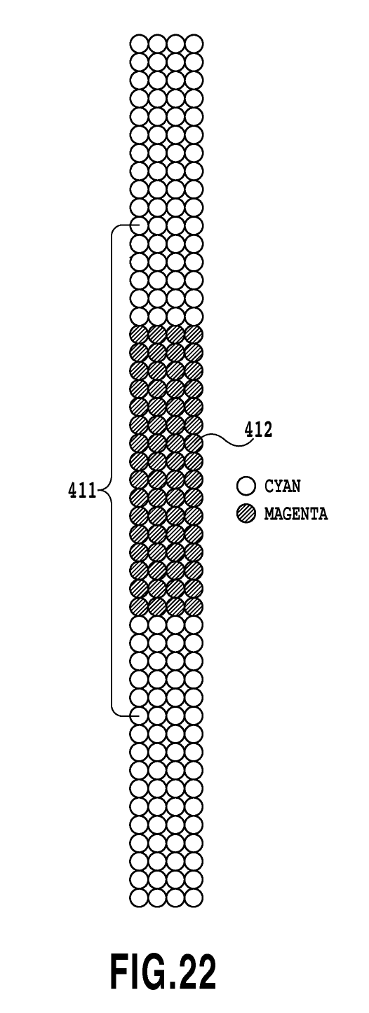

FIG. 21 shows an example of a test pattern formed on a print medium in step S11. The test pattern includes, for example, seven test patches 401 to 407. The procedure of creating each test patch will be described with reference to FIG. 22.

First, in a reference test patch 5404, 16 cyan ink ejection ports with nozzle numbers 8 to 23 and 40 to 55 are used to print an image 411 formed of 16 dots in the sub-scanning direction and 4 dots in the main scanning direction. Then, a space portion corresponding to 16 dots in the sub-scanning direction and 4 dots in the main scanning direction is formed in the image 411. During the same scan, magenta ink ejection ports with nozzle numbers 24 to 39 are used to print an image 412 in the image 411. That is, a magenta pattern is printed so as to fill the space portion between the two cyan patterns.

On the other hand, the magenta print element group is shifted by a small amount with respect to the reference test patch and then used to print test patches 405, 406, and 407. That is, the magenta print element group is shifted so as to reduce each of the nozzle numbers by two; the nozzle numbers are 24 to 39 for the reference test patch 404, 22 to 37 for the test patch 405, 20 to 35 for the test patch 406, and 18 to 33 for the test patch 407. Also in this case, the block driving order remains unchanged.

Similarly, the magenta print element group is shifted in the opposite direction by a small amount with respect to the reference test patch and then used to print test patches 403, 402, and 401. That is, the magenta print element group is shifted so as to increase each of the nozzle numbers by two; the nozzle numbers are 24 to 39 for the reference test patch 404, 26 to 41 for the test patch 403, 28 to 43 for the test patch 402, and 30 to 45 for the test patch 401. Also in this case, the block driving order remains unchanged.

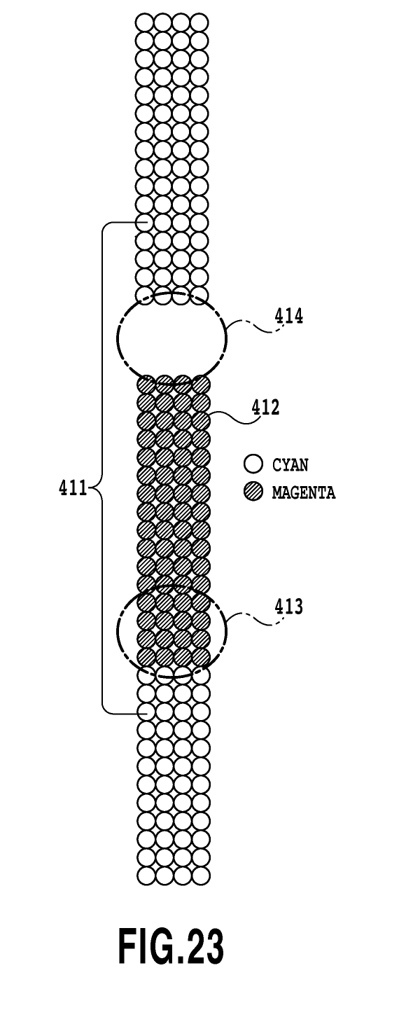

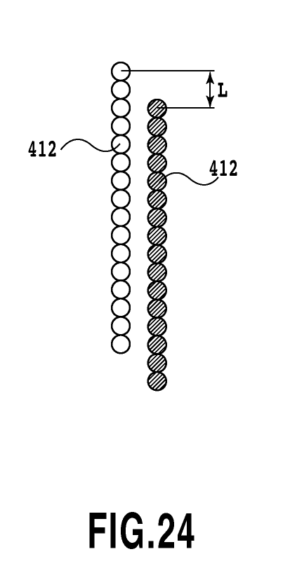

FIG. 23 is a diagram showing a dot arrangement in a test patch in which color misalignment has occurred. If color misalignment occurs in the sub-scanning direction, the test patch includes a portion 413 in which cyan dots overlap magenta dots and a portion 414 with no dot as shown in FIG. 23. Thus, black and white stripes are formed in the test patch. If color misalignment occurs in the sub-scanning direction, cyan dots 415 are misaligned with magenta dots 416 in the sub-scanning direction by a length L as shown in FIG. 24.

In the reference test patch 404, a magenta pattern is originally printed so as to fill the area between two cyan patterns. Thus, if color misalignment occurs in the sub-scanning direction, an overlapping portion and a space portion are formed between the cyan and magenta patterns as shown in FIG. 23. As a result, the test patch shows black and white stripes.

Then, the detection of the color misalignment amount, in this case, the amount of misalignment between each cyan dot and the corresponding magenta dot in the sub-scanning direction will be described. In the description, it is assumed that one of the seven test patches in FIG. 21 which is denoted by “+4” shows no black or white stripe and thus has a uniform print density.

The test patch 406 is printed by shifting the nozzle numbers of the magenta print element group from 24 to 39 for the reference pattern to 20 to 35. Originally, without color misalignment, black and white stripes are formed as shown in FIG. 23. However, since color misalignment has actually occurred, the color misalignment is offset by the shifting of the print element group to form a test patch 906 with a uniform print density. In this case, the amount L of misalignment between each cyan dot and the corresponding magenta dot is +4 pixels.

A test patch showing an image with a uniform print density is selected from the plurality of test patches 401 to 407 created by gradually shifting the print element group used for magenta. Then, the color misalignment amount in the sub-scanning direction can be detected and acquired. That is, in step S12, the reflective optical densities of the seven test patches are measured using the optical sensor. Then, after this optical measurement, a test patch offering an output value corresponding to a high reflective optical density is selected. Then, a test patch having a uniform dot arrangement and showing no black or white stripe can be detected. In this example, the test patch 406 is selected, and the color misalignment amount L is determined to be +4. A color misalignment amount L of +4 is thus acquired.

In the above-described example, the following simple configuration is provided: the optical sensor is used to select a test patch with the most uniform dot arrangement, and based on the magenta print element group used form this test patch, information on color misalignment is detected. However, instead, the following configuration may be provided. For example, optical characteristics of the test patches are measured, and test patches with the highest and second highest reflective optical densities are selected. Then, the difference in reflective optical density between the two test patches is calculated. If the difference in reflective optical density is equal to or larger than a predetermined value, the misalignment amount of the test patch with the highest reflective optical density is adopted directly as information on color misalignment. If the difference in reflective optical density is equal to or smaller than the predetermined value, the average of the misalignment amounts of the test patches with the highest and second highest reflective optical densities may be selected. Alternatively, an approximate line or an appropriate curve may be determined, by straight-like approximation or polynomial approximation, based on the data on the optical characteristics of the test patches located to the right and left, respectively, of the test patch with the highest reflective optical density. Then, information on color misalignment may be detected based on the intersection point between the right and left straight lines or curves.

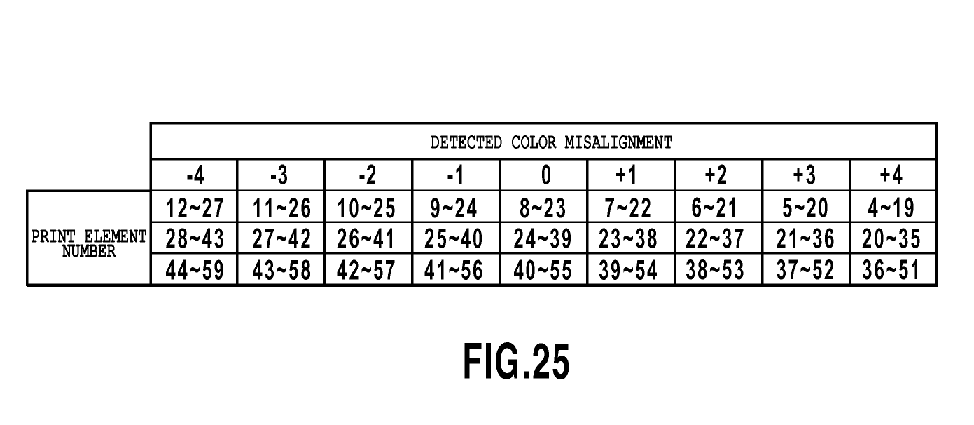

In connection with steps S13 and S14, the relationship between the color misalignment amount and the print element group used, such as the one shown in FIG. 25, is pre-stored in the correction value storage unit 217 in table form. Then, the print element group used corresponding to the actually detected color misalignment amount is read and determined to be the final print element group used. For the color misalignment amount L=0, the reference print element group used involves the nozzle numbers 8 to 55. For “+4”, the print element group used is set to correspond to the nozzle numbers 4 to 51.

As described above, the misalignment correction according to the present embodiment changes the print element group used and the block driving order to set dot impact positions on the print medium to be the same for different colors. This enables degradation of the print quality to be inhibited or prevented or allows the image quality to be improved. Also, if the misalignment in the sub-scanning direction exists among the print element arrays for the same color and the range of the print element used is changed, positions of the dots of this color can be aligned and an improvement of the image quality can be realized together with changing the block driving order.

The embodiment of the present invention has been described in detail. However, the present invention may take other embodiments.

Furthermore, the present invention is also implemented by executing the following process. That is, software (program) configured to provide the functions of the above-described embodiment is supplied to a system or an apparatus via a network or any of various storage media. Then, a computer (or CPU, MPU, or the like) in the system or the apparatus may read and execute the program.

While the preset invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-183540, filed Aug. 6, 2009, which is hereby incorporated by reference herein in its entirety.

What is claimed is:

1. A printing apparatus including a plurality of print element arrays each with a plurality of print elements arranged therein, the printing apparatus printing an image by time division driving in which the plurality of print elements in each print element array are divided into a plurality of blocks and in which the print elements are driven for every block, the apparatus comprising:
an acquisition unit for acquiring the amount of misalignment among the print element arrays in an arrangement direction of the print elements;
a correction unit for changing a print element group used for printing in at least one print element array in accordance with a misalignment amount acquired by the acquisition unit to correct the misalignment among the print element arrays; and
a changing unit for changing a driving order of the blocks in accordance with the misalignment amount.

2. The printing apparatus according to claim 1, wherein the changing unit comprises a first storage unit configured to store reference block driving order data, a determination unit for determining an offset value corresponding to the acquired misalignment amount, and a second storage unit for storing the reference block driving order data such that the reference block driving order data is rearranged based on the offset value, and
wherein the print elements in the at least one print element array is driven in accordance with the block driving order data stored in the second storage unit.

3. The printing apparatus according to claim 2, wherein the determination unit determines the offset value corresponding to the acquired offset amount based on a table configured to specify a relationship between the misalignment amount and the offset value.

4. The printing apparatus according to claim 1, wherein the correction unit determines the print element group corresponding to the acquired misalignment amount based on a table configured to specify a relationship between the misalignment amount and the print element group used for printing.

5. A printing method of using a plurality of print element arrays each with a plurality of print elements arranged therein to print an image by time division driving in which the plurality of print elements in each of the print element arrays are divided into a plurality of blocks and in which the print elements are driven for every block, the method including:
an acquisition step of acquiring the amount of misalignment among the print element arrays in an arrangement direction of the print elements;
a correction step of changing a print element group used for printing in at least one print element array in accordance with the misalignment amount acquired in the acquisition step to correct the misalignment among the print element arrays; and
a changing step of changing a driving order of the blocks in accordance with the misalignment amount.
